(19) United States
(12) Patent Application Publication
(10) Pub. No.: US 2010/0211736 A1
(43) Pub. Date: Aug. 19, 2010

(54) METHOD AND SYSTEM FOR PERFORMING I/O OPERATIONS ON DISK ARRAYS

(76) Inventors: Gang Chen, Pudong (CN); Xinhai Kang, San Jose, CA (US)

Correspondence Address: HARNESS, DICKEY & PIERCE P.L.C., 5445 CORPORATE DRIVE, SUITE 200, TROY, MI, 48098, US

(21) Appl. No.: 12/707,688

(22) Filed: Feb. 18, 2010

Related U.S. Application Data
(60) Provisional application No. 61/153,477, filed on Feb. 18, 2009.

(51) Int. Cl. G06F 12/00

(52) U.S. Cl. 711/114; 711/E12.001

(57) ABSTRACT

A method and system for performing input/output (I/O) operations on disk arrays are disclosed. The method for performing I/O operations on disk array comprises: determining whether the data layout of a row of storage units in a disk array related to an I/O operation request is a first layout or a second layout; if it is a first layout, the I/O operation corresponding to the first layout will be performed on the row of storage units; otherwise, the data layout of the row of storage units will be converted from the second layout to the first layout, and the I/O operation corresponding to the first layout will be performed on the row of storage units.

### CROSS-REFERENCE TO RELATED APPLICATIONS

This application claims the benefit of U.S. Provisional Application No. 61/153,477, entitled “Method to Improve The Degrade RAID5 I/O Performance”, filed on Feb. 18, 2009, the disclosure of which is incorporated herein by reference in its entirety.

### FIELD OF THE INVENTION

The present invention generally relates to the field of storage devices and, more particularly, to a method and system for performing I/O operations on disk arrays.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

A redundant array of independent disks (RAID) combines a plurality of physical disks into an array. The array acts as a logical disk and stores data on different physical disks in blocks. When data is accessed, related physical disks in the array work in parallel, which significantly shortens the time to access data and improves space utilization. Although a RAID comprises a plurality of physical disks, it appears as an independent, monolithic large storage device to an operating system. Relative to a single storage device of the same capacity, the RAID can offer excellent fault tolerant capability in addition to improved performance. When any of the physical disks fails, the RAID can continue to function without being affected by the failed physical disk. RAID has several different levels (e.g. RAID0, RAID1, RAID0+1, RAID3, RAID5, etc.), which have different speeds, security performance and performance price ratios. A proper RAID level can be selected according to actual applications to satisfy a user's demand for memory availability, performance and capacity.

RAID0 represents the highest storage performance among all RAID levels. RAID0 improves storage performance as follows (as shown in FIG. 1): continuous data are spread across a plurality of physical disks for access. A system's data request can be executed in parallel by a plurality of physical disks. Each physical disk executes the corresponding part of the data request for data stored thereon. Such parallel operation of data can make full use of a bus bandwidth and remarkably improve the overall access performance of RAID0 disk arrays. The shortcoming of RAID0 is that it does not offer data redundancy. As a result, in the event of data damage, the damaged data cannot be recovered. The features of RAID0 make it particularly appropriate for fields with high performance demand but less concern with data security, such as a graphics workstation.

RAID5 is a RAID with fault tolerant capability. Its fault tolerance is not achieved by employing a dedicated parity physical disk but through evenly distributing parity information across all physical disks thereof. When one physical disk fails in a RAID5 disk array, the disk array can compute the lost data based on corresponding data on several other physical disks. Since lost information must be computed from data on other disks, an additional physical disk with a certain capacity is needed to ensure that other member disks can correctly reconstruct the lost data. The total capacity of a RAID5 disk array equals the product of the number of physical disks thereof (assumed to be N) minus 1 (N−1) and the capacity of the physical disk with the smallest capacity. When one physical disk in a RAID5 disk array fails, the data on the failed physical disk can be reconstructed based on the parity information on other physical disks. But if two physical disks fail at the same time, all data will be lost.

FIG. 2 shows the data layout of an exemplary RAID5 disk array. As shown in FIG. 2, the RAID5 disk array comprises 5 physical disks, each of which is further divided into 5 storage units and storage units at the same position of all disks form a stripe. Data blocks 0-19 and parity blocks P1-P5 are distributed in 25 storage units as shown in FIG. 2 (which are numbered in the order of data blocks 0-19 entering the disk array). Each data block can also be indicated by the position (x, y) in the RAID5 disk array, wherein x refers to the stripe that the data block is located on and y refers to the physical disk that the data block is located on.

For ease of illustration herein, the RAID5 disk array with one failed physical disk is referred to as a degraded RAID5 disk array. FIG. 3 shows the data layout of the RAID5 disk array in FIG. 2 after being degraded (in FIG. 3, Disk 3 fails). To recover the lost data, data blocks of each stripe are read from all physical disks of the RAID5 disk array. A XOR operation is performed on the read data blocks to calculate the lost data blocks. For example, to calculate the data block (0, 3) in FIG. 3, data blocks (0, 0), (0, 1), (0, 2) and (0, 4) are acquired and a XOR operation is performed on these data blocks. In addition, in the write process on the degraded RAID5 disk array, a read operation is also performed on other physical disks so as to acquire sufficient data blocks on the stripes and a XOR operation is performed on these data blocks to calculate the data that should have been written into each storage unit.

As previously mentioned, the read and write performance of a degraded RAID5 disk array is greatly weakened relative to that of a non-degraded RAID5 disk array. At the same time, a degraded RAID5 disk array has zero data redundancy and has the same protection against data loss as that of a RAID0 disk array, but the performance is much poorer than that of a RAID0 disk array.

### SUMMARY

In light of the above problems, the present disclosure provides a method and system for performing improved I/O operations on disk arrays.

The method for performing I/O operations on disk arrays according to embodiments of the present disclosure comprises: determining whether the data layout of a row of storage units in a disk array related to an I/O operation request is a first layout or a second layout; if it is a first layout, the I/O operation corresponding to the first layout is performed on the row of storage units; otherwise, the data layout of the row of storage units is converted from the second layout to the first layout, and the I/O operation corresponding to the first layout is performed on the row of storage units.

The system for performing I/O operations on disk arrays according to embodiments of the present disclosure comprises: a layout determination unit configured to determine whether the data layout of a row of storage units in a disk array related to an I/O operation request is a first layout or a second layout; and an execution unit configured to perform I/O operations corresponding to the first layout on the row of storage units when the data layout of the row of storage units is the first layout, or convert the data layout of the row of storage units from the second layout to the first layout when the data layout of the row of storage units is the second layout, and perform I/O operations corresponding to the first layout on the row of storage units.

The present disclosure can significantly improve I/O operation performance of disk arrays.

### BRIEF DESCRIPTION OF THE DRAWINGS

The present invention can be better understood by way of the description of embodiments of the present invention below with reference to the accompanying drawings, wherein:

FIG. 1 is a schematic showing the working principle of an exemplary RAID0 disk array;

FIG. 2 is a schematic showing the data layout of an exemplary RAID5 disk array;

FIG. 3 is a schematic showing the data layout of the exemplary RAID5 disk array in FIG. 2 after being degraded;

FIG. 4 is a flow chart showing a method for performing I/O operations on disk arrays according to an embodiment of the present disclosure;

FIG. 5 is a block diagram showing a system for performing I/O operations on disk arrays according to an embodiment of the present disclosure;

FIG. 6 is a schematic showing the corresponding relation between the data layout of the RAID5 disk array after the data layouts of some stripes are converted and the bitmap for recording the data layout;

FIG. 7 is a flow chart showing a method for performing a read operation (output operation) on the degraded RAID5 disk array according to an embodiment of the present disclosure; and

FIG. 8 is a flow chart showing a method for performing a write operation (input operation) on the degraded RAID5 disk array according to an embodiment of the present disclosure.

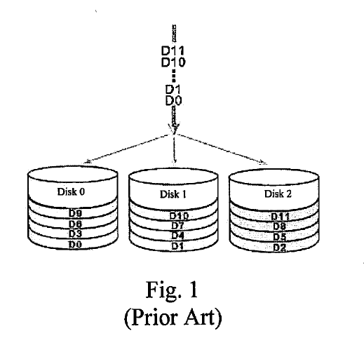

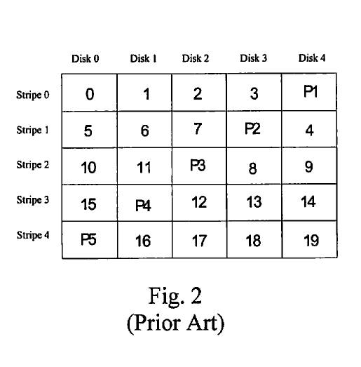

### DETAILED DESCRIPTION

Features in all aspects of the present disclosure and exemplary embodiments thereof will now be described in detail. The description below covers a lot of specific details to offer a full understanding of the present disclosure. However, it is obvious to those skilled in the art that the present disclosure can be embodied without some of these specific details. The description of embodiments below is intended to provide a clearer understanding of the present disclosure through various examples. The present disclosure is by no means limited to any specific configuration or algorithm described below. Various modifications, changes, replacements and/or improvements can be made to relevant elements, components and algorithms thereof without departing from the spirit of the present disclosure.

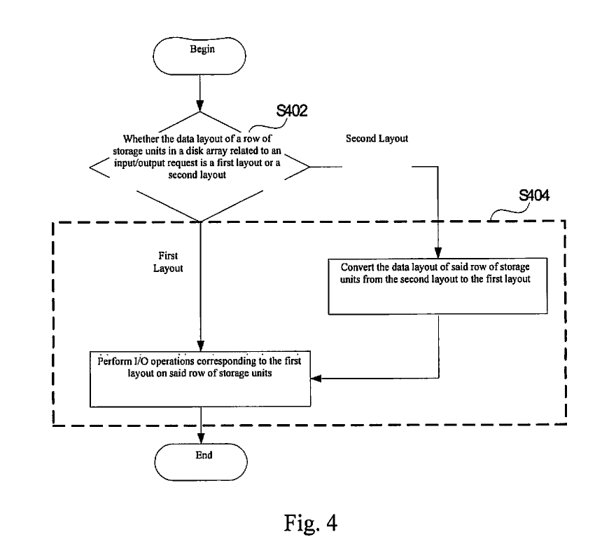

FIG. 4 is a flow chart showing a method for performing I/O operations on disk arrays according to an embodiment of the present disclosure. As shown in FIG. 4, at S402, it is determined whether the data layout of a row of storage units in a disk array related to an I/O operation request is a first layout or a second layout. At S404, if it is determined that the data layout is a first layout, the I/O operation corresponding to the first layout will be performed on the row of storage units; otherwise, the data layout of the row of storage units will be converted from the second layout to the first layout, and the I/O operation corresponding to the first layout will be performed on the row of storage units.

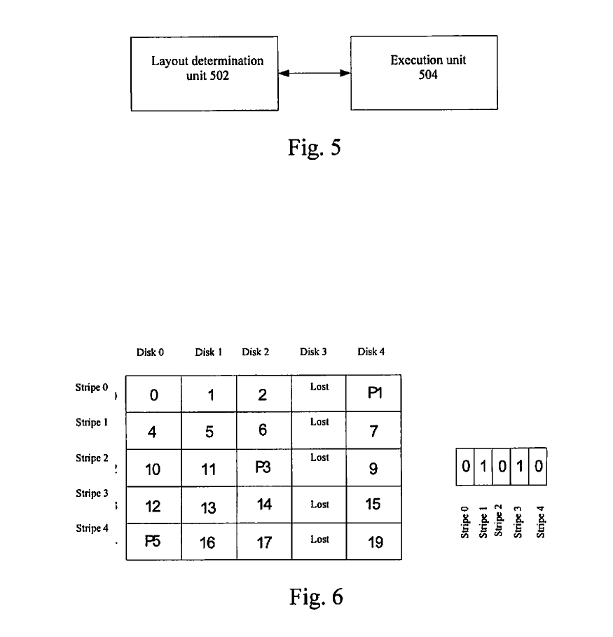

FIG. 5 is a block diagram showing a system for performing I/O operations on disk arrays according to an embodiment of the present disclosure. As shown in FIG. 5, the system comprises a layout determination unit 502 and an execution unit 504. The layout determination unit 502 determines whether the data layout of a row of storage units in a disk array related to an I/O operation request is a first layout or a second layout (i.e., executes Step S402). The execution unit 504 performs I/O operations corresponding to the first layout on the row of storage units when the data layout of the row of storage units is the first layout, or converts the data layout of the row of storage units from the second layout to the first layout when the data layout of the row of storage units is the second layout, and performs I/O operations corresponding to the first layout on the row of storage units (i.e., executes Step S404).

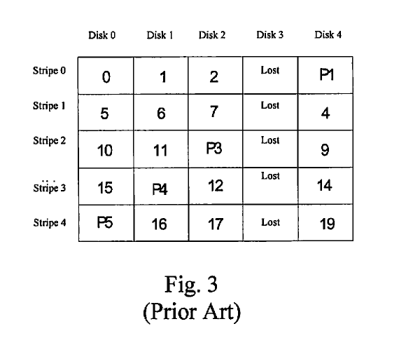

The method and system according to embodiments of the present disclosure are described below through an example of performing I/O operations on a degraded RAID5 disk array (e.g. as shown in FIG. 3).

FIG. 6 shows the corresponding relation between the data layout of the RAID5 disk array after the data layouts of some stripes are converted as shown in FIG. 3 and the bitmap for recording the data layout. In the bitmap for recording the data layout of the RAID5 disk array, for example, 0 represents a RAID5 data layout and 1 represents a RAID0 data layout.

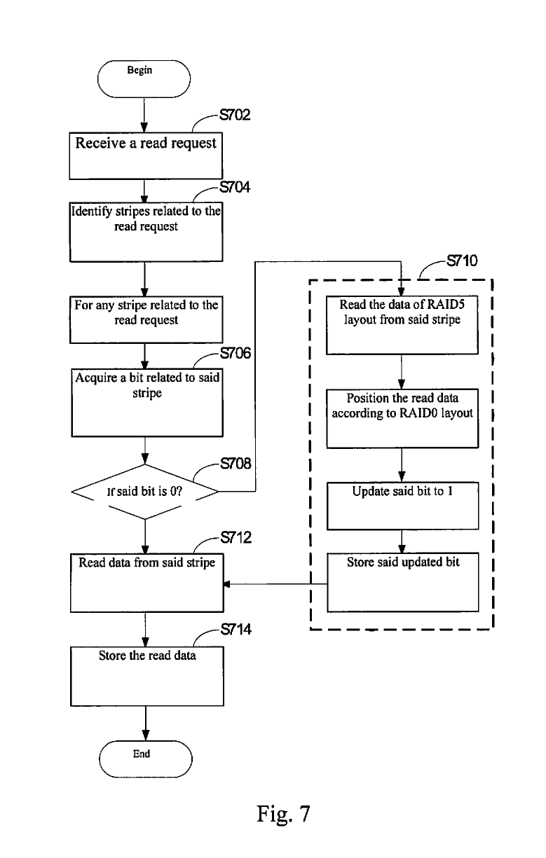

FIG. 7 is a flow chart showing a method for performing a read operation on the degraded RAID5 disk array according to an embodiment of the present disclosure. As shown in FIG. 7, at S702, a read request is received. At S704, it is determined which stripes in the degraded RAID5 disk array are related to the read request. For any stripe that is related to the read request, the following is performed. At S706, a bit in the bitmap is acquired for recording the data layout of the RAID5 disk array that is related to the stripe. At S708, it is determined whether the bit is 0. If the bit is 0, the process goes to S710. At S710, the data of RAID5 layout is read from said stripe, and the read data is re-positioned according to RAID0 layout. The bit related to the stripe is updated to 1, and the updated bit is stored into a nonvolatile storage device. The process then continues to S712.

If the bit is not 0 as determined at S708, the process goes directly to S712. At S712, data is read from the stripe, and the process then goes to S714. At S714, the read data is stored.

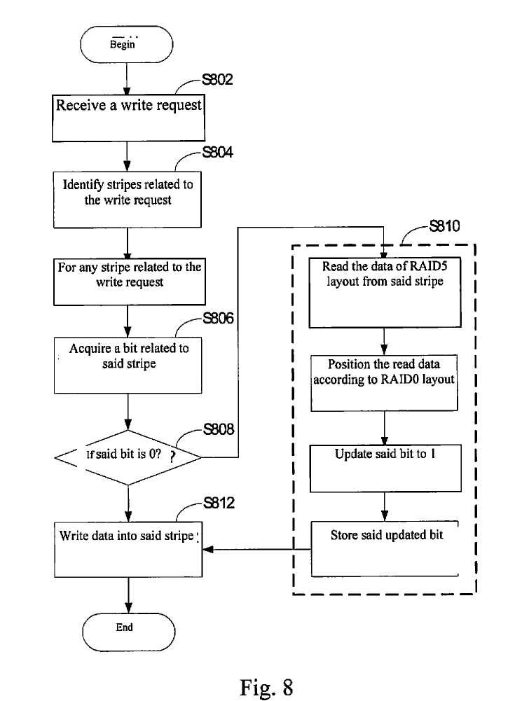

FIG. 8 is a flow chart showing a method for performing a write operation on the degraded RAID5 disk array according to an embodiment of the present disclosure. As shown in FIG. 8, at S802, a write request is received. At S804, it is determined which stripes in the degraded RAID5 disk array are related to the write request. For any stripe that is related to the write request, the following is performed. At S806, a bit in the bitmap is acquired for recording the data layout of the RAID5 disk array that is related to the stripe. At S808, it is determined whether the bit is 0. If the bit is 0, the process goes to S810. At S810, the data of RAID5 layout is read from the stripe, and the read data is re-positioned according to RAID0 layout. The bit related to the stripe is updated to 1. The updated bit is stored into a buffer or a nonvolatile storage device. The process then continues to S812.

If the bit is not 0 as determined at S808, the process goes directly to S812. At S812, data is written into the stripe.

For the degraded RAID5 disk array, the present disclosure changes one or more stripes thereof on which I/O operations are to be performed from RAID5 data layout to RAID0 data layout, such that the one or more stripes can achieve the processing performance equal to that of RAID0 in subsequent I/O operations. As a result, the overall I/O performance of the degraded RAID5 disk array is improved. In other words, the present disclosure improves the write and read performance of a degraded RAID5 disk array to that of a RAID0 disk array without compromising the data security.

Moreover, the present disclosure is not limited to applications in the above embodiments. When two disk arrays or disks have the same protection level (i.e. redundancy) and space utilization (i.e. capacity), but their performances are different due to different data layouts, the method and system according to the present disclosure can be employed to adjust the data layout of the disk array or disk that has the relatively poorer performance so as to improve performance of I/O operations on such disk array or disk. It should be noted that the adjustment of the data layout of the disk array or disk with the relatively poorer performance is a gradual process. Adjustment is only made on data layouts of accessed (i.e. being read or being written) stripes on an one-by-one basis.

The present disclosure is described above with reference to certain embodiments. However, it is obvious to those skilled in the art that various modifications, combinations and variations may be made to these embodiments without departing from the spirit and scope of the present disclosure as indicated by the appended claims or any equivalents thereof.

Hardware or software may be used to execute the steps if necessary. It should be noted that steps may be added into or eliminated from the flow charts herein or steps therein may be modified as long as they do not depart from the scope of the present disclosure. Generally speaking, flow charts are only used to indicate possible sequences to realize basic operations of a function.

Embodiments of the present disclosure can be realized by way of common digital computers for programming, special integrated circuits, programmable logic devices, field programmable gate arrays, and optical and nano engineering systems, components and mechanisms. Generally speaking, based on the disclosure and teachings provided herein, the functions according to the present disclosure can be realized via any known means in the field, such as distributed or connected systems, components and circuits. Data communication or transmission can be realized via wired, wireless or any other means.

It should also be noted that one or more elements indicated in the drawings may be realized in a further separated or further integrated manner, or even be removed or not implemented under certain circumstances as required by specific applications. It is also within the spirit and scope of the present disclosure to realize programs or codes stored in machine-readable media so as to allow computers to execute any of the above methods.

Furthermore, any signal, arrow in the drawings shall be deemed as illustrative only instead of restrictive, unless otherwise instructed. When the terms are not clear on separation or combination, the combination of components or steps shall be deemed having been recorded.

What is claimed is:

1. A method for performing I/O operations on disk arrays, the method comprising:
determining whether a data layout of a row of storage units in a disk array related to an I/O operation request is a first layout or a second layout;
if the data layout is the first layout, performing an I/O operation corresponding to the first layout on the row of storage units; and
if the data layout is the second layout, converting the data layout from the second layout to the first layout, and performing the I/O operation corresponding to the first layout on the row of storage units.

2. The method according to claim 1, wherein the disk array is a degraded RAID5 disk array.

3. The method according to claim 2, wherein the first layout is a RAID0 data layout and the second layout is a RAID5 data layout.

4. The method according to claim 3, wherein the data layout of the row of storage units is determined to be whether the first layout or the second layout based on a bitmap that represents data layouts corresponding to rows of storage units of the disk array.

5. The method according to claim 4, wherein the bitmap is updated after the data layout of the row of storage units is converted from the second layout to the first layout.

6. The method according to claim 5, wherein the bitmap is stored in a nonvolatile storage device.

7. A system for performing I/O operations on disk arrays, the system comprising:
a layout determination unit configured to determine whether a data layout of a row of storage units in a disk array related to an I/O operation request is a first layout or a second layout; and
an execution unit configured to convert the data layout from the second layout to the first layout when the data layout is the second layout, and perform I/O operations corresponding to the first layout on the row of storage units.

8. The system according to claim 7, wherein the disk array is a degraded RAID5 disk array.

9. The system according to claim 8, wherein the first layout is a RAID0 data layout and the second layout is a RAID5 data layout.

10. The system according to claim 9, wherein the layout determination unit determines whether the data layout is the first layout or the second layout based on a bitmap that represents data layouts for corresponding rows of storage units of the disk array.

11. The system according to claim 10, wherein the execution unit updates the bitmap after the data layout is converted from the second layout to the first layout.

12. The system according to claim 11, wherein the bitmap is stored in a nonvolatile storage device.
